(19) United States
(12) Patent Application Publication
(10) Pub. No.: US 2006/0182209 A1
(43) Pub. Date: Aug. 17, 2006

(54) Multi-sampling monobit receiver

(75) Inventors: Paul T. Coyne, Endicott, NY (US); Thomas A. Moch, Owego, NY (US); Daniel S. Parsons, Owego, NY (US)

Correspondence Address: Edmund J. Walsh;Wolf, Greenfield & Sacks, P.C., 600 Atlantic Avenue, Boston, MA, 02210-2206, US

(73) Assignee: Lockheed Martin Corporation, Bethesda, MD (US)

(21) Appl. No.: 11/060,185

(22) Filed: Feb. 17, 2005

(51) Int. Cl. H04B 1/10

(52) U.S. Cl. 375/349

(57) ABSTRACT

A receiver operating at high frequencies with low measurement error. Multiple frequency measurements are made using digital signal processing. Each measurement is based on sampled data acquired with a low resolution but high sample rate analog to digital converter. The converters are clocked at sampling frequencies that are not rationally related, causing the frequency measurement error of each circuit to differ at every frequency. Based on the multiple frequency measurements, the receiver selects an output frequency.

### FEDERALLY SPONSORED RESEARCH

This invention was made with Government support under ______. The Government may have certain rights to this invention.

### FIELD OF INVENTION

The invention relates generally to communication systems, including electronic surveillance systems, and more specifically to receivers.

### BACKGROUND OF INVENTION

Digital processing techniques have found widespread use in signal processing applications previously dominated by analog methods. Factors driving the migration have included reduction in power, chip size, and recurring cost, in addition to a reduction or elimination of calibration and temperature sensitivity. Additionally, compared to previous analog methods, digital approaches also posses the ability to handle more complex signals and signal scenarios.

Analog to digital (A/D) converters are enabling components of digital processing techniques that convert a significant analog signal into digital data composed of a stream of time-sampled bits, thereby enabling the digital manipulation of input signals.

Unfortunately, A/D converter performance is limited by an inverse correlation between bandwidth (i.e. sampling rate) and dynamic range (i.e. bits per sample). As bandwidth is increased, dynamic range decreases. This inverse relationship imposes limits on both the bandwidth and dynamic range of digital receivers, restricting the applications where digital processing may be successfully utilized. Fortunately, applications demanding high bandwidths, with minimal requirements on dynamic range, benefit greatly from a reduction in the number of bits, or restrictions, employed in digital signal representations. An extreme example is the monobit A/D converter, which digitizes an input analog signal into a 1 bit digital data stream, enabling sampling rates in excess of several gigahertz (GHz).

In communication systems, such as electronic surveillance systems, monobit receivers have been built using 1 bit A/D converters. Digital signal processing modules can use the stream of digital data for applications where signal phase is more relevant than amplitude, including measurement of frequency, phase modulation and frequency modulation. For example, frequency measurements may be performed by converting an input signal into a 1 bit digital signal via an A/D converter, processing the resultant signal with a correlator (or equivalently with a FFT module), determining the maximum amplitude so as to establish a coarse frequency measurement, and calculating the phase slope, at that coarse frequency, so as to obtain a fine frequency measurement.

FIG. 1 shows a block diagram form a prior art frequency measurement system using a single bit analog to digital converter. The input signal is sampled in analog to digital converter 110. Analog to digital converter 110 is clocked at a sampling rate of Fₛ₁. The output of analog to digital converter 110 is provided to a frequency measurement circuit 112.

Frequency measurement circuit 112 includes a correlator 114. Samples of the input signals are provided to correlator 114. Correlator 114 receives multiple signal prototypes from a circuit, which may be a memory 116. Correlator 114 and signal prototype memory 116 act as a frequency domain transformation on the input. The signal prototypes stored in memory 116 may be considered basis functions for the transformation. Correlator 114 has one output for each of the signal prototypes, representing a coefficient associated with that signal prototype. The input signal can be represented by the superposition of all the signal prototypes, each multiplied by its respective coefficient.

Each signal prototype generally represents a signal of a different frequency. Therefore, each output of correlator 114 represents the extent to which the input contains a component of a certain frequency.

The coefficients from correlator 114 are applied to a converter circuit 118. The coefficients produced by correlator 114 are complex numbers, having both a real and imaginary component. Converter 118 converts each coefficient from a form having a real and imaginary component to a form having a magnitude and a phase.

The output of converter 118 is applied to channel select circuit 120. Channel select circuit 120 identifies the frequency components in the input more specifically, and channel select circuit 120 identifies channels that have significant non-zero values. The signals in the selected channels can be further analyzed. Channel select circuit 120 provides a control input to multiplexer 122. The control input to multiplexer 122 ensures that the channels out of converter 118 having significant signals are passed through multiplexer 122 for further analysis.

Phase slope calculator 124 tracks the phase of the coefficient in the selected channel over time. The rate of change of the phase, or its slope, is an indication of the frequency of a signal. By combining the rate of change of the phase and frequency information about the signal prototype corresponding to the selected channel, a frequency of a signal within the selected channel can be determined with a relatively high degree of accuracy. This computation is performed in frequency converter 126.

Monobit receivers such as shown in FIG. 1 possess high sampling rates via the utilization of 1 bit A/D converters. But, we have recognized that as a result of monobit data representations, input signals with frequencies fractionally related to the sampling rate are difficult to discriminate from each other over short time intervals. Frequency measurement errors occur for specific input frequencies related to the sampling rate and reduce the accuracy of monobit receivers.

FIG. 2A illustrates frequency measurement errors such as may occur with a monobit receiver as shown in FIG. 1. The error curve has multiple spikes such as 212, 214, 216, 218 and 220. These spikes in measurement error occur at frequencies that are related to the sampling frequency. For example, spike 212 may correspond to a frequency that is one-quarter the sampling frequency. Spike 214 may correspond to a frequency that is three-tenths the sampling frequency. Spike 216 may correspond to a frequency that is one-third of the sampling frequency. Spike 218 may correspond to a frequency that is three-eighths of the sampling frequency. Spike 220 may correspond to a frequency that is two-fifths of the sampling frequency. Having such large spikes at so many frequencies is undesirable.

These errors are not caused by frequency aliasing induced by sampling below the Nyquist Rate, but rather arise from the monobit signal representation, and therefore are problematic for both sampling frequencies below and above the Nyquist Rate.

A need therefore exists for a method and corresponding receiver architecture to reduce or eliminate measurement errors introduced by low dynamic range sampling.

### SUMMARY OF INVENTION

In one aspect, the invention relates to a method of processing an input. The method includes sampling the input at a plurality of sampling rates to produce a plurality of digital signals; estimating the frequency of a component of the input using the digital signals; and determining a frequency of the component from at least one of the plurality of digital signals, with the determination based on the estimated frequency and the measurement error at each of the sampling rates.

In another aspect, the invention relates to a method of processing an input. The method includes sampling the input in a plurality of low resolution analog to digital converters, each having a different sampling rate, to produce a plurality of digital signals; making a plurality of estimates of the frequency of a component of the input, each estimate being made using one of the plurality of digital signals; and selecting a frequency of the component from the plurality of estimated frequencies, wherein selecting a frequency of the component from the plurality of estimated frequencies comprises selecting with a voting algorithm.

In yet another aspect, the invention relates to apparatus for processing an input. The apparatus includes a plurality of analog to digital converters, each analog to digital converter clocked to provide a different sampling frequency and having a digital output; a plurality of digital frequency measurement circuits, each digital frequency measurement circuit receiving as an input the output of an analog to digital converter and providing as an output an estimate of a frequency of a component in the input signal; and a selection circuit, the selection circuit having a plurality of inputs, each coupled to the output of a frequency measurement circuit and having an output representing a measured frequency, the measured frequency being less than half the sampling frequency of each of the plurality of different sampling frequencies.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a prior art monobit receiver;

FIG. 2A is a sketch illustrating frequency measurement error associated with a prior art monobit receiver;

FIG. 2B is a sketch of frequency measurement error associated with an improved receiver;

FIG. 3 is a block diagram of an improved receiver; and

FIG. 4 is a block diagram of an alternative embodiment of a receiver.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

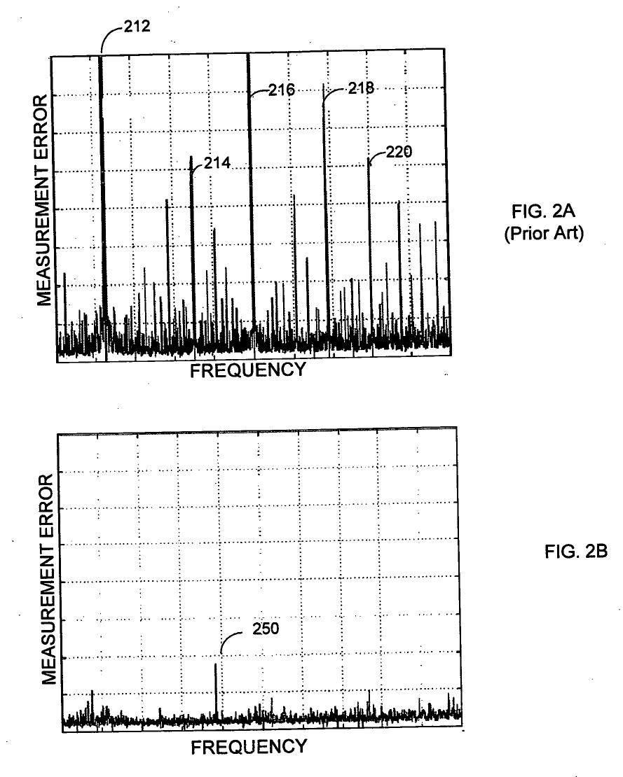

FIG. 2B represents a sketch of a more desirable frequency measurement error profile. The frequency measurement error profile shown in FIG. 2B has a relatively uniform and low level of measurement error across the frequency spectrum of interest. The profile contains a spike 250, but there are many fewer spikes in this measurement profile and the spikes are much smaller than shown in FIG. 2A.

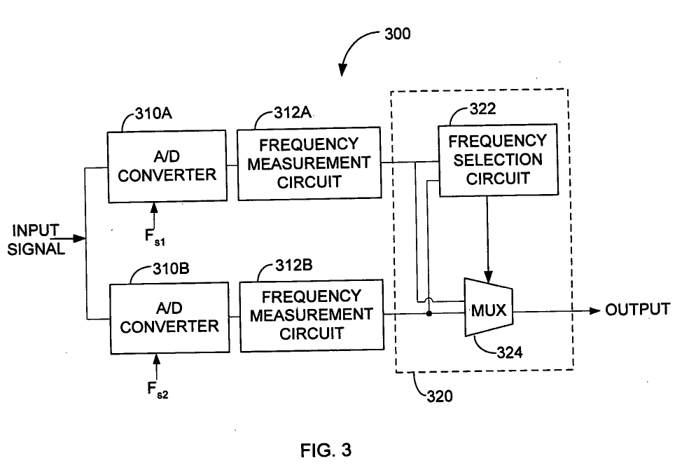

FIG. 3 shows an improved receiver 300. Receiver 300 includes two analog to digital converters 310A and 310B. The input signal is applied to both analog to digital converters 310A and 310B. Analog to digital converters 310A and 310B may be similar to converter 110 as used in the prior art.

Preferably, analog to digital converter 310A and 310B have different sampling frequencies. Analog to digital converter 310A is shown to be sampled at a frequency Fₛ₁ while analog to digital converter 310B is sampled at a frequency Fₛ₂. Preferably, Fₛ₁ and Fₛ₂ are not related by a multiple that is an integer or any rational fraction (i.e., can be represented as a ratio of two integers).

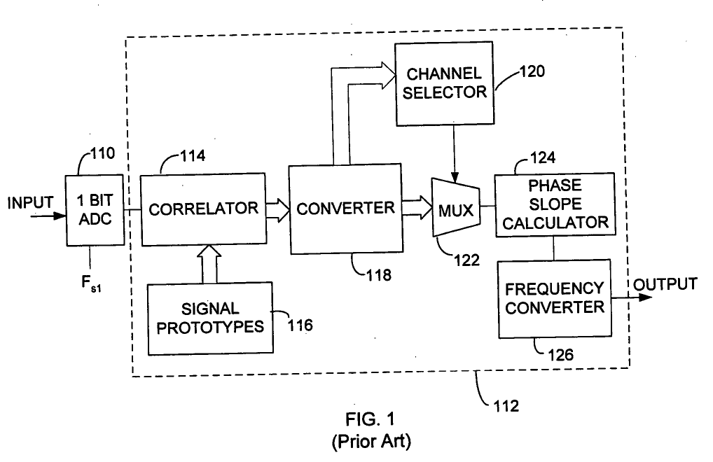

The output of analog to digital converter 310A is applied to a frequency measurement circuit 312A. Frequency measurement circuit 312A may be a frequency measurement circuit similar to circuit 112 (FIG. 1). Likewise, the output of analog to digital converter 310B is provided to a frequency measurement circuit 312B. Frequency measurement circuit 312B may also be similar to frequency measurement circuit 112 (FIG. 1).

The combination of analog to digital converter 310A and frequency measurement circuit 312A produces an estimate of the frequency of the input signal. Analog to digital converter 310B in combination with frequency measurement circuit 312B produces a second estimate of the frequency of the input signal. Each of these estimates will be produced with a frequency measurement circuit having a measurement error profile generally as illustrated in FIG. 2A. However, the sampling frequencies Fₛ₁ and Fₛ₂ used to produced each measurement profile will be different. Preferably, the sampling frequencies will be selected such that the spikes for the measurement error associated with 312A could occur at different frequencies than the spikes in the measurement error profile for frequency measurement circuit 312B. Accordingly, for each frequency at which an input signal will occur, one of the frequency measurement circuits 312A or 312B will measure that frequency with a relatively low measurement error.

The outputs of frequency measurement circuit 312A and 312B are applied to a selection module 320. Selection module 320 is here shown to include a multiplexer 324 that receives as switched inputs the measured frequency from each of frequency measurement circuit 312A and 312B. The control input to multiplexer 324 is provided by a frequency selection circuit 322. Frequency selection circuit 322 also receives as inputs the measured frequencies from frequency measurement circuits 312A and 312B and provides the control input to multiplexer 324. The control input causes multiplexer 324 to pass to the output through the frequency measurement having the lowest measurement error. Frequency selection circuit 322 may be constructed to perform according to various algorithms.

In one embodiment, frequency selection circuit 322 is programmed with a data table constructed from the frequency measurement error profiles of each frequency measurement circuit 312A and 312B. Such data may be determined empirically or computed based on the sampling frequency of each of the analog to digital converters 310A and 310B. The data table in frequency selection circuit 322 may accept as inputs the frequency estimates produced by frequency measurement circuits 312A and 312B. Such inputs identify an estimated frequency or a frequency range likely containing the frequency of the input signal. The data value at the location in the table corresponding to each pair of inputs indicates the frequency measurement circuit, either frequency measurement circuit 312A or 312B, that has the lowest frequency measurement error in the estimated frequency range. Frequency selection circuit 322 uses the value in the data table to generate a control input to multiplexer 324, causing the output of the identified frequency measurement circuit to be passed through to the output of selection module 320. This output represents the measured frequency of the entire receiver 300. Such an output has a frequency measurement error corresponding to the frequency measurement error of either frequency measurement circuit 312A or 312B, whichever is lower for that specific frequency.

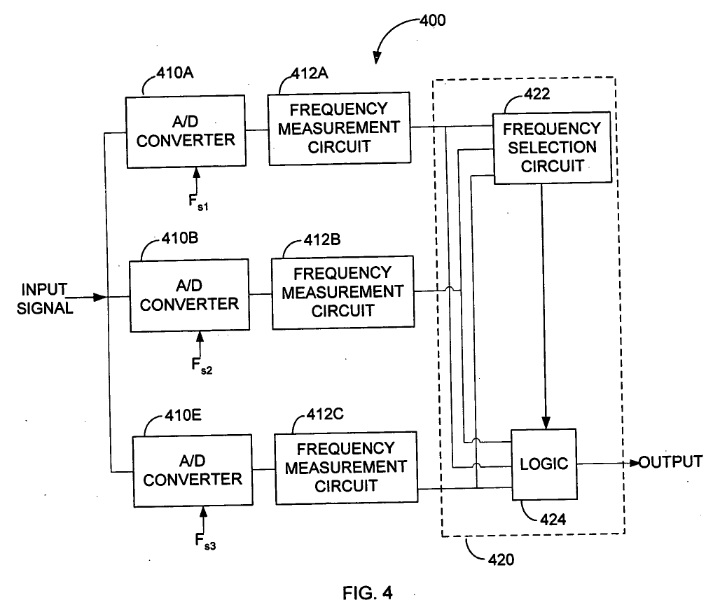

FIG. 4 shows an alternative embodiment of a receiver 400. Here, receiver 400 makes three separate frequency measurements. The input signal is sampled in three separate analog to digital converters 410A, 410B, and 410C. In the illustrative embodiment, analog to digital converters 410A, 410B, and 410C may be similar to analog to digital converter 110 (FIG. 1). The output of each of the analog to digital converters 410A, 410B, and 410C is provided to a frequency measurement circuit 412A, 412B, and 412C, respectively. Each of the frequency measurement circuits 412A, 412B, and 412C produces an estimate of the frequency of the input signal. Such circuits may be in the form of frequency measurement circuit 112 (FIG. 1).

Preferably, each of the analog to digital converters 410A, 410B, and 410C is clocked by a sampling clock of a different frequency. Preferably, none of the sampling clocks has a frequency that is related to any other sampling frequency by an integer multiple or a rational fraction. This selection of sampling frequencies ensures that each of the frequency measurement circuits 412A, 412B, and 412C has peaks in its error profiles at different frequencies. Accordingly, for each frequency for which a measurement may be made, the output of some of the frequency measurement circuits 412A, 412B or 412C will contain more error and others will contain less error.

Selection module 420 outputs an indication of the measured frequency computed from the estimated frequencies output from frequency measurement circuits 412A, 412B, and 412C.

In one embodiment, frequency selection module 420 operates in any of a number of ways to determine the frequency to output. Frequency selection circuit 422 may operate in much the same way as frequency selection 322 (FIG. 3). In such an embodiment, frequency selection circuit 422 is programmed with a data table identifying, for each combination of estimated frequencies, the frequency measurement circuit having the lowest measurement error. For such an embodiment, logic 424 may be a multiplexer similar to multiplexer 324 shown in FIG. 3. Frequency selection circuit 422 provides a control input to the multiplexer in logic 424, causing it to pass through the output of the frequency measurement circuit expected to have the lowest measurement error.

As an alternative, frequency selective circuit 422 may operate according to a median algorithm. The estimated frequencies output by each of the frequency measurement circuits, such as 412A, 412B, 412C, may be ordered from lowest to highest. Frequency selection circuit 422 may control logic 424 to select the middle or “median” value. Such an approach may work without modification for any odd number of frequency measurement circuits. To use a median algorithm for an even number of signals, a measured frequency must be assigned even though there are two middle frequencies. Any suitable approach may be used. For example, the two middle values could be averaged. Alternatively, the middle frequency value closest to the average of all frequency values or the middle value closest to the next nearest frequency value could be selected.

As a further alternative, selection module 420 may employ a voting method. In a voting method, frequency selection circuit 422 examines the output of each of the plurality of frequency measurement circuits such as 412A, 412B, and 412C. Frequency selection circuit 422 identifies the frequency estimate that differs most from the other two. The estimate that is most different is assumed to be an error. The remaining two estimates are then processed to compute a final output representing the measured frequency.

Logic block 424 may process the remaining two frequency measurements in one of several ways. The two values may be averaged to compute a output frequency. Alternatively, the frequency measurement of the remaining two measurements closest to the average of the frequency measurements may be passed through logic block 424.

As yet a further alternative, selection module 420 may employ a hypothesis testing approach. In hypothesis testing, the measurement error profiles of each of the frequency measurement circuits 412A, 412B, and 412C would be used. With the measurement error profiles, selection module 420 can predict the output measurement of each of the frequency measurement circuits for a specific frequency in the input signal. Selection module 420 would compute for many hypothesized input frequencies expected frequency estimates out of each of the frequency measurement circuits 412A, 412B, and 412C. Selection module 420 would then compare the actual frequency measurements to the predicted frequency measurement for multiple hypothesized input frequencies. The set of predicted measurements most closely matching the actual measurements would, therefore, indicate the best estimate of the frequency of the input signal. This frequency value would be output by selection module 420 as the measured output frequency.

The above-described receivers provide a more accurate measurement of frequency, particularly for relatively high frequency measurements, over a relatively wide bandwidth. For example, the receiver may have a bandwidth of at least 2 GHz with the lower end of that bandwidth at or above 2 GHz. Such a receiver is well suited for signal measurements where signal phase is more important than signal amplitude. Such a receiver may, for example, be employed as an interferometer or in systems that decode signals that have phase or frequency modulation.

Having thus described several aspects of at least one embodiment of this invention, it is to be appreciated various alterations, modifications, and improvements will readily occur to those skilled in the art. For example, the receivers employing the invention are described as useful in making measurements on relatively high frequency signals that demand a high sampling rate. In the described embodiments, the sampling rates are all taken to be above the Nyquist rate for the signals being measured. In these embodiments, the output frequency will be less than or equal to half of the lowest sample rate used. For example, sampling rates above 5 GHz may be employed. In some embodiments, the sampling rates will be between 5 GHz and 10 GHz. For example, the receiver 400 of FIG. 4 may employ sampling rates of 8.3 GHz, 8.7 GHz, and 9.0 GHz, which ensures that the sampling frequencies are not rationally related.

Analog to digital converters that are available at these high sampling rates generally have a low dynamic range. The invention can be employed with analog to digital converters that have as low as 1 bit of resolution. However, the invention may be employed with analog to digital converters having more bits of resolution.

Further, receivers employing two and three separate frequency measurements are described. However, the number of converters is not a limitation on the invention. Any number of converters may be used in the receiver. As more converters are provided for frequency measurements at more sampling rates, selection module 420 would select an output frequency based on the measurements produced at each sampling frequency. The approaches used by the selection modules such as 320 and 420 described above could be extended to select an output frequency from any number of measured frequencies. For example, where selection module employs a look-up table, the table may be extended to accommodate more inputs. Where more than three frequency estimates are provided, a voting technique may operate by selecting the estimated frequency occurring most frequently. Alternatively, providing more frequency measurements may allow statistical techniques to be used to identify the output frequency. For example, the average frequency may be selected as the output. Such an average may be produced using all of the frequency measurements or an average may be taken over only the frequency measurements that are clustered around a certain frequency.

Further, it should be appreciated that in some embodiments selection module such as 320 and 420 produces an output by selecting one of the frequency measurements. However, a receiver according to the invention need not be limited to outputting a frequency corresponding to one of the measurements. A frequency may be selected by averaging, hypothesis testing or other approach that selects an output frequency based on —but not necessarily equal to one of—the measured frequencies.

Also, the specific technology used to implement the receivers according to the invention is not a limitation on the invention. Circuitry as used to construct conventional high speed analog and digital systems may be employed. However, other implementations are possible.

Additionally, a receiver is described that measures a single frequency component in an output signal. Such a receiver may be employed to form a channel in a multi-channel receiver, which would process input signals having multiple frequency components. Such alterations, modifications, and improvements are intended to be part of this disclosure, and are intended to be within the spirit and scope of the invention. Accordingly, the foregoing description and drawings are by way of example only.

What is claimed is:

1. A method of processing an input comprising:
a) sampling the input at a plurality of sampling rates to produce a plurality of digital signals;
b) estimating the frequency of a component of the input using the plurality of digital signals; and
c) determining a frequency of the component from at least one of the plurality of digital signals, with the determination based on the estimated frequency and the measurement error at each of the sampling rates.

2. The method of claim 1 wherein sampling comprises sampling with a plurality of single bit analog to digital converters.

3. The method of claim 2 wherein sampling in each of the single bit analog to digital converters comprises sampling above the Nyquist rate.

4. The method of claim 1 wherein determining a frequency comprises selecting the frequency of a component in the digital signal sampled at the sampling rate having the lowest measurement error at the estimated frequency.

5. The method of claim 1 wherein determining a frequency comprises:
a) accessing a location in a look-up table, the look-up table indexed by the frequency estimated for each of the plurality of sampling rates, the lookup table storing an indication of one of the plurality of digital signals; and
b) using a frequency estimated for the digital signal indicated at the accessed location as the determined frequency.

6. The method of claim 1 wherein determining a frequency comprises selecting the frequency of a component in the digital signal sampled at the sampling rate having the lowest measurement error at the estimated frequency.

7. The method of claim 1 wherein none of the plurality of sampling rates comprises at least three sampling rates, none of which is rationally related to the others of the plurality of sampling rates.

8. The method of claim 7 wherein estimating the frequency of a component comprises estimating the frequency at each of the sampling rates and determining the frequency of a component of the input signal comprises selecting one of the estimated frequencies.

9. The method of claim 8 wherein selecting one of the estimated frequencies comprises employing a voting algorithm.

10. The method of claim 8 wherein selecting one of the estimated frequencies comprises employing a hypothesis testing algorithm.

11. A method of processing an input comprising:
a) sampling the input in a plurality of low resolution analog to digital converters, each having a different sampling rate, to produce a plurality of digital signals;
b) making a plurality of estimates of the frequency of a component of the input, each estimate being made using one of the plurality of digital signals; and
c) selecting a frequency of the component from the plurality of estimated frequencies, wherein selecting a frequency of the component from the plurality of estimated frequencies comprises selecting a median of the plurality of estimates of the frequency.

12. The method of claim 111 wherein the plurality of low-resolution analog to digital converters comprises mono-bit analog to digital converters.

13. The method of claim 12 wherein the sampling rate of each of the analog to digital converters is above the Nyquist rate.

14. The method of claim 13 wherein making each of the plurality of estimates of frequency comprises performing a frequency domain transform on a sampled signal.

15. The method of claim 13 wherein the sampling rates of the plurality of analog to digital converters are not rationally related.

16. The method of claim 15 wherein making each of the plurality of estimates of frequency comprises estimating a frequency in a range including 2 GHz to 4 GHz.

17. Apparatus for processing an input comprising:
a) a plurality of analog to digital converters, each analog to digital converter clocked to provide a different sampling frequency and having a digital output;
b) a plurality of digital frequency measurement circuits, each digital frequency measurement circuit receiving as an input the output of an analog to digital converter and providing as an output an estimate of a frequency of a component in the input signal; and
c) a selection circuit, the selection circuit having a plurality of inputs, each coupled to the output of a frequency measurement circuit and having an output representing a measured frequency, the measured frequency being less than half the sampling frequency of each of the plurality of different sampling frequencies.

18. The apparatus of claim 17 wherein the selection circuit comprises:
a) a first sub-circuit receiving the plurality of estimated frequencies and providing an output identifying a subset of the estimated frequencies; and
b) a second sub-circuit, receiving the output of the first sub-circuit and providing, in response to the output of the first sub-circuit, the output of the selection circuit.

19. The apparatus of claim 18 wherein the first sub-circuit comprises a lookup table and the second sub-circuit comprises a multiplexer passing one of the estimates of the frequency in response to the output of the first sub-circuit.

20. The apparatus of claim 18 wherein the second sub-circuit comprises a logic circuit computing an average of selected ones of the estimates of the frequency in response to the output of the first sub-circuit.
